(19) United States
(12) Patent Application Publication
(10) Pub. No.: US 2008/0005669 A1
(43) Pub. Date: Jan. 3, 2008

(54) LIFE EVENT RECORDING SYSTEM

(76) Inventors: Frode Eilertsen, Cambridge, MA (US); John D. Shumway, Concord, MA (US); Alex Tarasenko, Sharon, MA (US); George Tarasenko, Stoughton, MA (US)

Correspondence Address: GOODWIN PROCTER LLP;PATENT ADMINISTRATOR, EXCHANGE PLACE, BOSTON, MA, 02109-2881, US

(21) Appl. No.: 11/754,203

(22) Filed: May 25, 2007

Related U.S. Application Data
(60) Provisional application No. 60/808,400, filed on May 25, 2006.

(51) Int. Cl. G06F 17/00; G06F 3/00

(52) U.S. Cl. 715/526; 715/500; 715/700

(57) ABSTRACT

In general, in one aspect, a method for facilitating on-line creation of a journal for a life event includes creating a template storyboard relevant to the life event, prepopulating the storyboard with content relevant to the life event, receiving photographs from a user, facilitating the editing and personalization of the storyboard by the user, including adding photographs received from the user; and providing the user with a journal in response to the edited storyboard.

### RELATED APPLICATIONS

This application claims priority to, and the benefit of, U.S. Patent Application Ser. No. 60/808,400, attorney docket number PAN-001PR, entitled LIFE EVENT RECORDING SYSTEM, filed May 25, 2006, incorporated herein by reference.

### FIELD

The invention relates to providing a web based software applications for presenting information, and more particularly, to a web based system for life event recording and sharing.

### BACKGROUND

During life events, such as trips, religious events, sports events, music events/concerts/tours, just as a few examples, people take photographs and want to share them. It is frequently difficult to do so in a way that is both interesting for the viewer and easy for the author.

### SUMMARY

In general, in one aspect, the method relates to facilitating on-line creation of a recording for a life event. The recording may be any sort of recording, but in a preferred embodiment, is a work that includes pictures, graphics, and text that describes the event in a manner that is interesting to the viewer. Exemplary recordings may be similar to journals, scrapbooks, and the like. In one embodiment, the recording may be viewed on a computer or other electronic display, and may also be printed into a bound paper book.

The method includes creating a template storyboard relevant to the life event. This may be performed by the user, but more typically is performed by an administrator, which may be a provider of a system for recording life events, or the vendor of the event or activities related to the event, such as a tour provider, wedding planner, and so on. For example, for a group travel experience, the tour vendor may provide a storyboard that is organized according to the itinerary for the trip, and that includes information about the places visited by the participants. For a wedding, the storyboard may include the various events leading up to the wedding day, as well as different parts of the event (e.g., ceremony, dancing, cutting cake, etc.).

With respect to a music concert and/or tour, a storyboard may include artist and show information, venue information, background information on the artistic material such as (but not limited to) song lyrics, choreography, scene settings, and so forth.

The method also includes prepopulating the storyboard with content relevant to the life event. This may include, in the trip example, descriptions mentioned above about the itinerary, as well as further detailed information about the sights visited. Other content may include “stock” or professional photographs relevant to the event, such as photographs of sights visited, and related graphics. Likewise, text that has general applicability, such as descriptions of cities, locations, relevant textual quotes, poems, writings, and the like may be provided. For example, for a wedding that takes place in a historical building, information about the building and the surrounding area, and a relevant photograph may be provided.

The method includes receiving photographs (and/or multimedia content) captured in the course of the event. The photographs may be received from a user, but may instead or in addition be provided by a professional photographer, or other photographer at the event. The photographs may be received from other participants at the event.

The method also includes facilitating the editing and personalization of the storyboard by the user, which may include adding photographs (and/or multimedia content) received from the user into the storyboard. For example, the user may edit and modify the order of the storyboard, graphics in the storyboard, add photographs to the storyboard, add or delete pages from the storyboard, add or delete text from the storyboard, and so on.

In one embodiment, the editing involves providing the user with a “What You See Is What You Get” (WYSIWYG) display of the edited storyboard, such that the user can understand what the final product will look like as the editing takes place. In one embodiment, this takes place using a web browser in communication with one or more web servers. Other servers in communication with a web server process the edit data and produce a graphic file that is representative of the edited storyboard.

The method includes providing the user with a recording in response to the edited storyboard. The recording may be on-line, in the form of the graphic file, or a collection of graphic files representative of the storyboard. The recording may be provided to a printer for printing and binding. The completed printed and bound recording may be provided to the user.

### BRIEF DESCRIPTION OF THE DRAWINGS

FIG. 1 is a log on screen in an exemplary embodiment.

FIG. 2 is a screen display of a library of page layouts in an exemplary embodiment.

FIG. 3 is a screen display for creating a participant site in an exemplary embodiment.

FIG. 4 is a screen display for creating photo sets in an exemplary embodiment.

FIG. 5 is a screen display for editing photo sets in an exemplary embodiment.

FIG. 6 is a screen display for managing event templates in an exemplary embodiment.

FIG. 7 is a screen display for creating a new event template in an exemplary embodiment.

FIG. 8 is a screen display for creating a new event template in an exemplary embodiment.

FIG. 9 is an exemplary itinerary in an exemplary embodiment.

FIG. 10 is a guide to journal editing in an exemplary embodiment.

FIG. 11 is a journal editing screen in an exemplary embodiment.

FIG. 12 is a journal administration screen in an exemplary embodiment.

FIG. 13 is an exemplary editing and publishing screen in an exemplary embodiment.

FIG. 14 is a new participant screen in an exemplary embodiment.

FIG. 15 is an exemplary registration page in an exemplary embodiment.

FIG. 16 is an exemplary registration page in an exemplary embodiment.

FIG. 17 is an exemplary log in screen in an in an exemplary embodiment.

FIG. 18 is an exemplary participant welcome page in an exemplary embodiment.

FIG. 19 is a media upload screen in an exemplary embodiment.

FIG. 20 is an exemplary screen of a photo uploader application in an exemplary embodiment.

FIG. 21 is an exemplary editing/ordering screen in an exemplary embodiment.

FIG. 22 is an exemplary sharing screen in an exemplary embodiment.

FIG. 23 is a block diagram of an exemplary system architecture in an exemplary embodiment.

FIG. 24 is an exemplary flowchart of the operation of dynamic WYSIWYG function in an exemplary embodiment.

### DETAILED DESCRIPTION

In general, in one aspect, a system for creating a recording specific to a life event includes an upload server for receiving from a user uploaded photographs taken at the event. Typically, the upload server communicates with a web browser, but may also communicate with an upload application that facilitates uploading of photographs. In some embodiments, in additional to photographs, audio, video, and/or some combination also may be uploaded.

Such a system may include a web server that provides an editing environment for editing life recording content. The content may include the uploaded photos/video/audio, a storyboard for the event, graphics relevant to the event, pre-populated information relevant to the event, and text provided by the user. The editor, for example, allows a user to take the storyboard, and change it to suit his or her interests, edit pre-populated content and graphics, add photographs, audio, video, and the like, as well as additional text and other information. The user can also add “stock” photos and content provided by an administrator, as well as content provided by other users. Once the user has personalized the recording, the user can view the recording.

A system also may include a resource server for translating the edited life recording content into a WYSIWYG format for display to the user. The system displays the content to a user such that the user can see what the printed recording will look like. In one embodiment, WYSIWYG content is generated specifically for the web browser that the user is using, taking into account browser size and resolution.

This may be accomplished, for example, by receiving browser size and resolution data from a browser, facilitating the editing and personalization of a graphic product by a user, generating a graphic file representative of the graphic product in response to the browser size and resolution data and the editing and personalization provided by the user; and transmitting the graphic file for display on the user's browser.

### EXEMPLARY EMBODIMENTS

The following description provides exemplary embodiments. Some figures, for example, refer to the “Panraven” system, as one exemplary implementation.

Overview

In some embodiments, a life recording system is offered to end users through channel partner, for example travel operators. Working with these channel partners, the system provides a personalized website and a pre-populated story which is populated with some number of event descriptions (for example, daily summaries of organized travel), background information (for example, descriptions of the places and the sights that a traveler experiences) and stock media (such as professional stock photos, illustrations, maps and other graphics from the places a travelers goes) for use by an end user. This allows the end user to craft a rich and complete chronicle of his/her experiences, with a fraction of the time/work required if they were to do this on their own, from scratch.

This document describes a process for configuring the system for a new ‘provider,’ and for building and pre-populating a journal for end customers (aka participants).

Defining a Provider

The system accommodates multiple “providers,” each having their administration, assets, event templates, events, participant web pages, automated emails, web site branding, photo uploader branding, pricing, and journal ‘look and feel’. Examples of ‘providers’ include (but are not limited to) tour operator partners, portal partners, and individuals and companies providing content describing an event and sharing it with others.

A new provider is provisioned within the system by establishing a provider code and a separate set of directories. Administrators are specified for the provider. Each provider may have one, two, or more administrators with different access privileges for creating, editing, publishing and deleting event templates, events, and photo sets (described below).

Branding

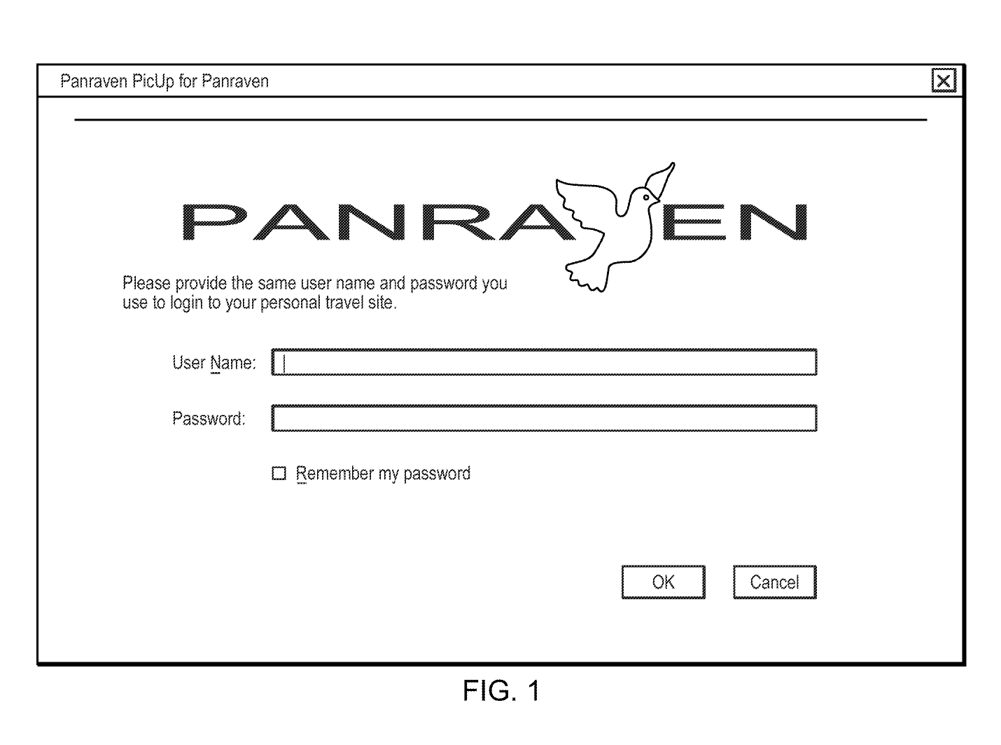

Referring to FIG. 1, special logos and End User License Agreements can be created for different providers. In the example, the branding of exemplary provider PANRAVEN is shown. This branding may be different for different providers.

Creating Page Layout Libraries

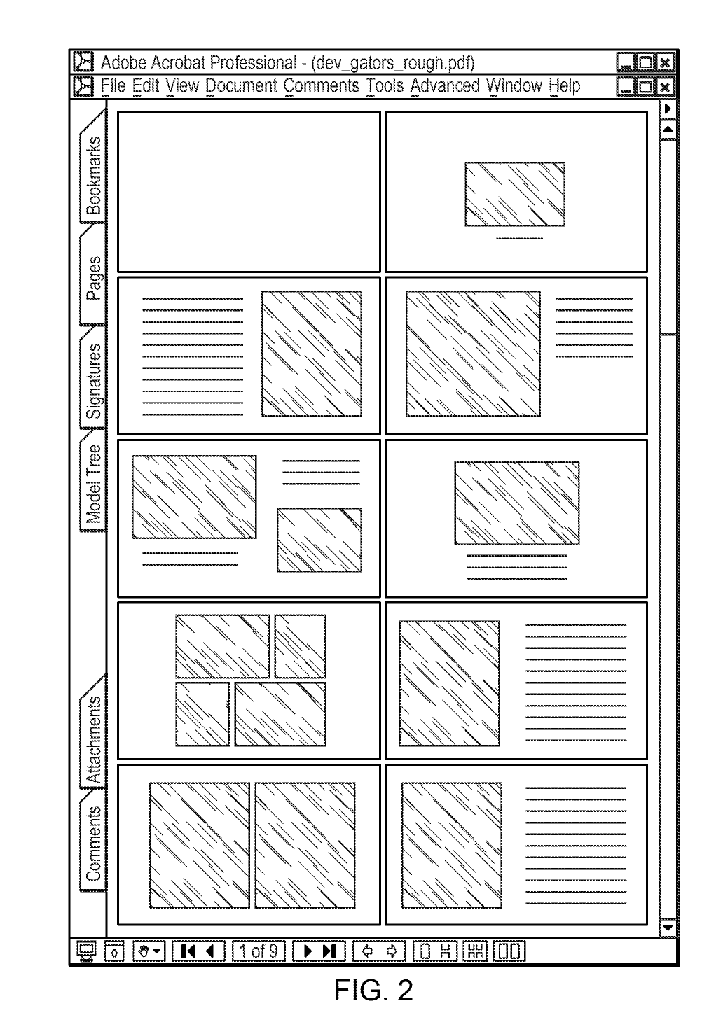

Referring to FIG. 2, page layouts may be grouped into a library of different page layouts, each having a combination of text and image frames, backgrounds, and ornamentation. One or more page layout libraries may be created for each provider and stored in the library. In some embodiments, the layouts may be configured and modified by the providers, such that the provider can customize and modify layouts. For example, a layout may include one, two, or more photos, and text configured on the side and/or underneath. The layouts allow a user to quickly select the presentation of information, including background graphics, taglines, and so forth.

Customizing State-Driven Web Pages for End Users

In one implementation, such a service provides personalized web pages for end users. These pages include variable data used to incorporate, among other things, the name of the registered end user which is included in a personal salutation (ex. “Greetings Chris and Michelle!”). Each provider has one or more sets of web pages that can be assigned to the event level. Within each web page set, there is full control for branding including the banner of the pages and all the text appearing on the pages. The pages may also include information specific to the registered end user, such as geographic/demographic information.

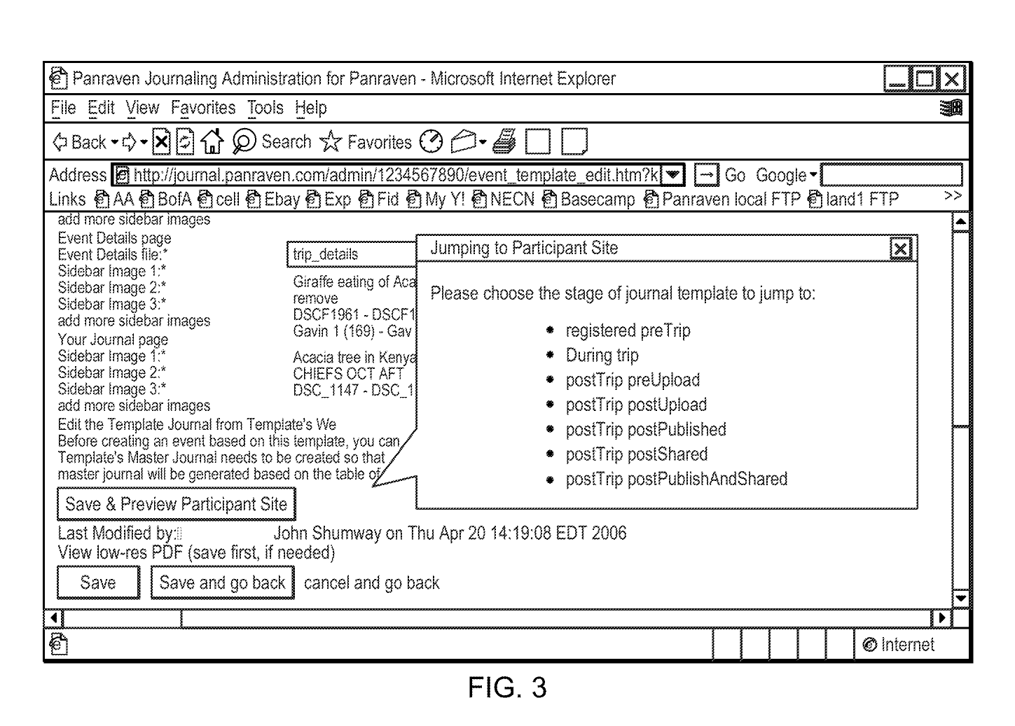

Referring to FIG. 3, in some embodiments, there may be variations of the site that are presented to a user, depending on a state to which the site is configured. For example, there may be different sites for pre-event, during event, post-event (but before media file upload), post-event after media filed upload, but before the journal building has begun, post-event/post published (e.g., user has ordered journal but not shared online), and post-event and after publishing and sharing. There may be, for example, each of these seven end user states available, each offering different welcome page text and navigation options for end users. End users are automatically taken to different versions of their configured web pages based on whether the particular event (any kind of event, such as a concert, a cruise, etc) has started and what post-event journaling activities they have already completed.

The figure shows an example screenshot for an administrator interface for a tour operator that shows different states for a trip. The administrator may select a state, and view the site as it would appear depending on whether or not a traveler has uploaded media files of type photos. This enables an administrator to view the web sites as the users might see it. As another example, a user in pre-trip state might be presented with travel guide information.

It should be understood that there may be one state, two states (e.g., pre-event and post event) or another number of states. For some events, and some audiences, having a large number of states may add too much complexity.

Creating Photo Sets or Sets of Stock Pages

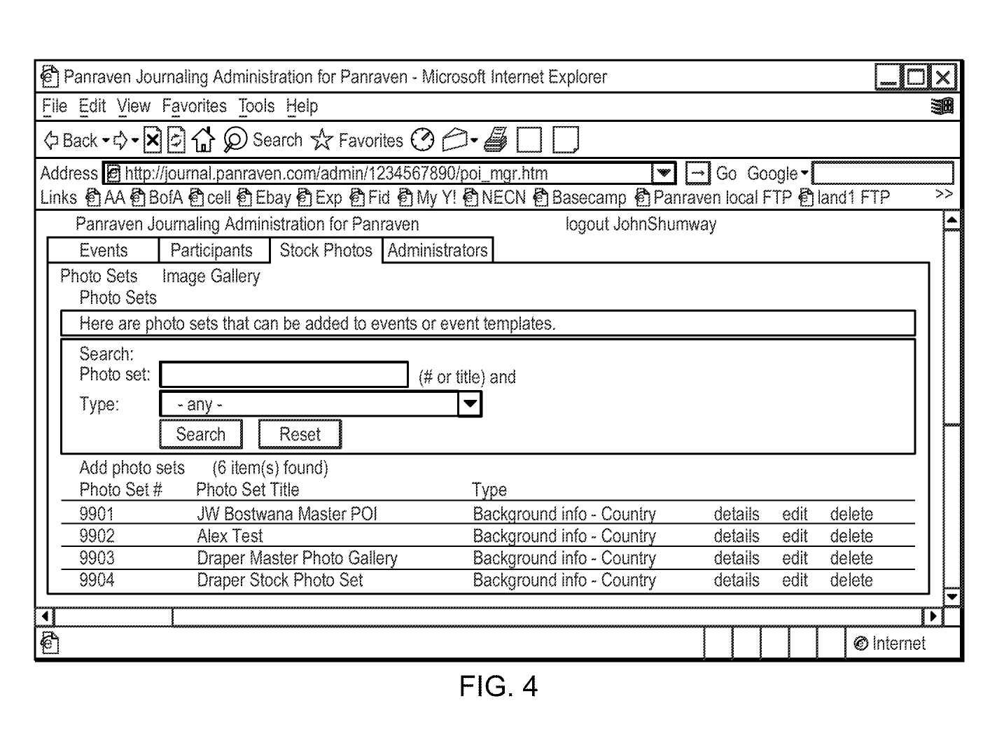

Referring to FIG. 4, photos sets (e.g., a collection of one or more images) may be created and managed through an administrator interface. One or more photos sets can be assigned to an entire event or any chapter of an event in Event Templates and Events. For example, if there are a number of different tours that travel through Paris, France, a photo set of Paris (e.g., images of Paris) may be associated with any tour or itinerary that includes Paris. When an administrator configures an event (by configuring an event template) or a user configures a storyboard (by selecting from available public photo sets), they may select an available photoset to include.

For example, photos from assigned photo sets may appear in a participant's Journal Editor as “Stock Photos.” A similar interface may be used for other digital content, such as video, audio, multimedia, and the like.

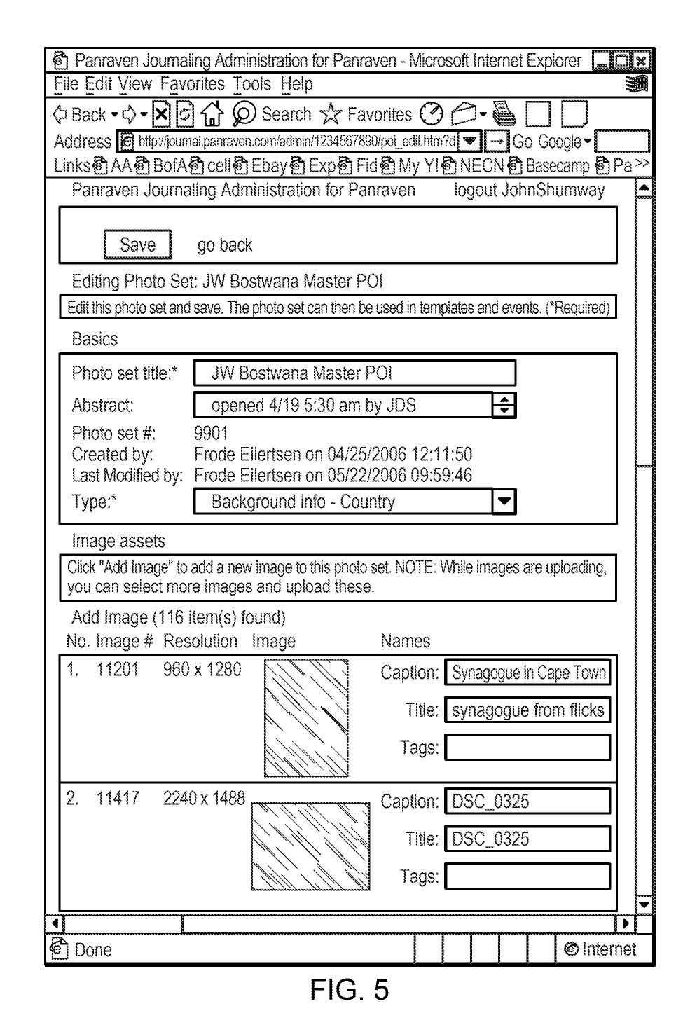

Referring to FIG. 5, a photo set may be created by specifying photo set title, abstract, and type (e.g., background information for a town/village, culture, history, geography; nature; places, travel), and then adding the individual photos with information such as caption, title, and tags for searching.

Creating Event Templates

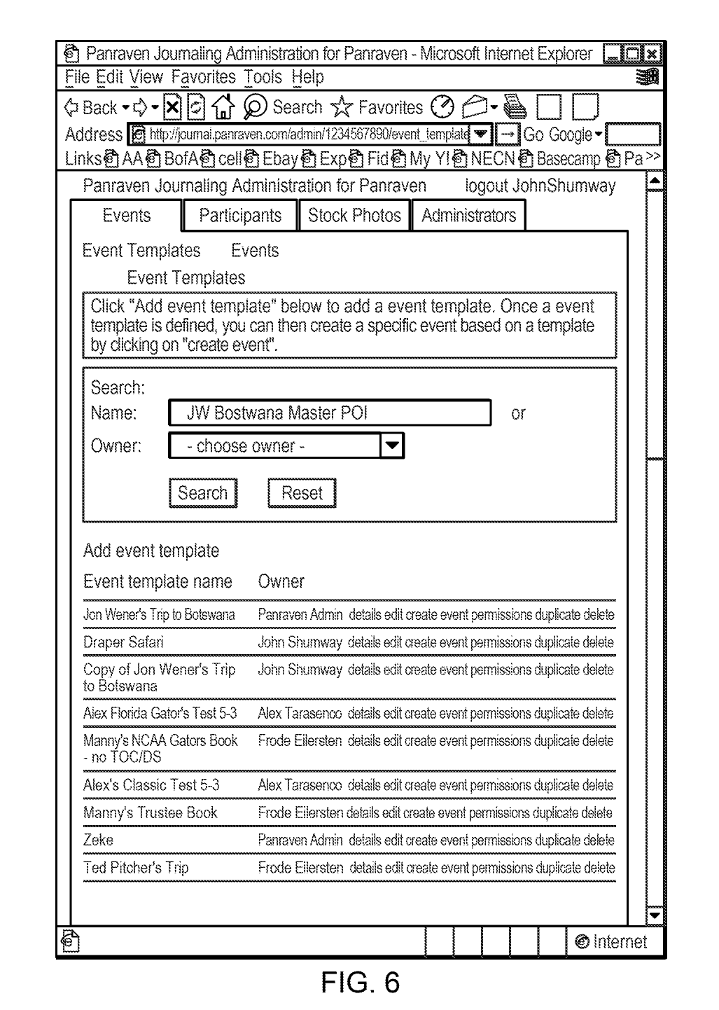

Referring to FIG. 6, an event template may be thought of as an pre-populated master journal for a particular event or type of event. For example, in the travel industry, an event template may be for a tour (ex. ‘Dubrovnik and Beyond—Hidden Jewels of the Adriatic’). This tour typically has many different events (aka departures or trips) occurring throughout the year. Pre-populated master journals for particular events may be created from event templates. In some embodiments, an event template may be used as the master journal. Thus, in various embodiments there may be one, two, or more levels of indirection. An event template may be used to create a master journal and a master journal used to create a user journal, or an event template may be used directly to create a user journal.

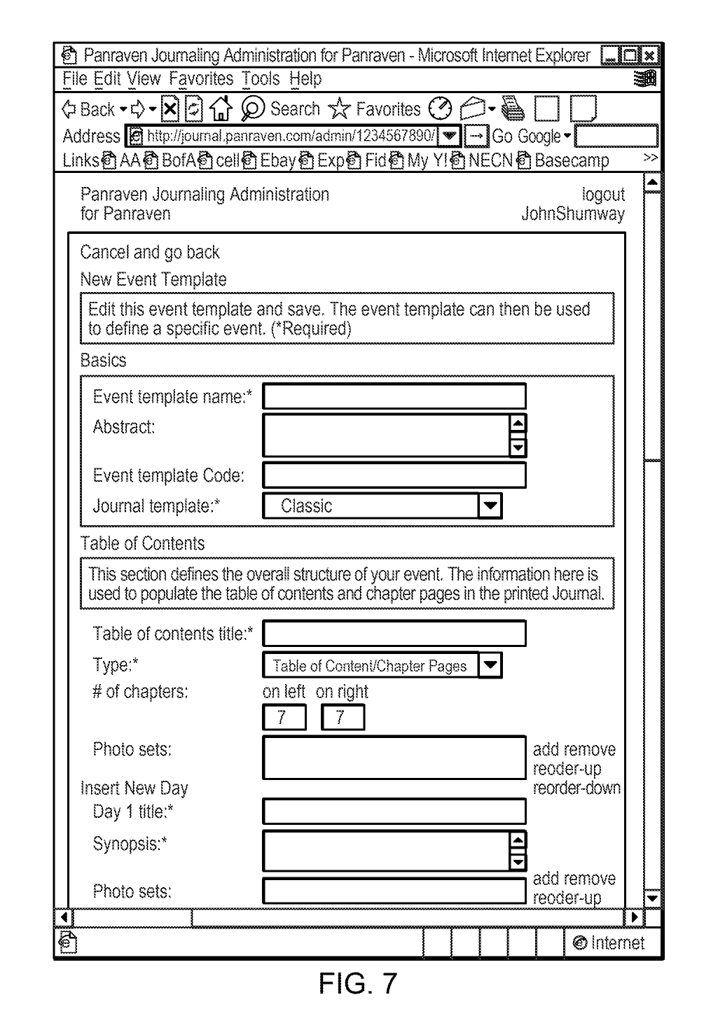

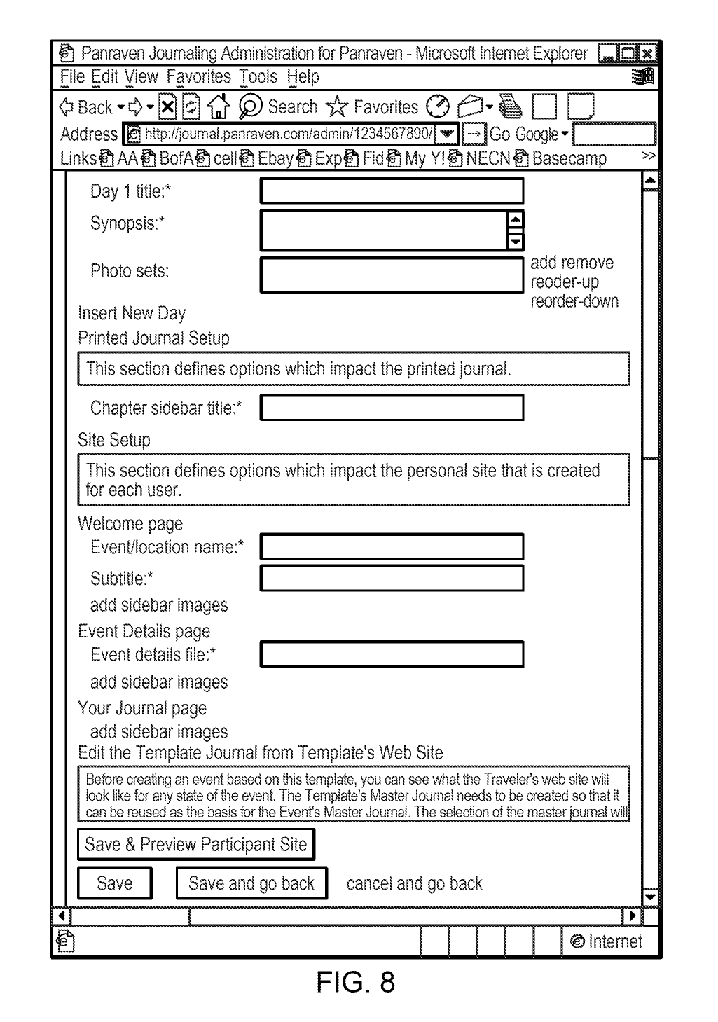

Referring to FIG. 7 and FIG. 8, new event templates may be created in two stages, basic setup and journal editing. Basic setup (FIG. 7) includes specifying such items as event template name; abstract; event template code; a selection of a journal template model (i.e., a page layout library to be associated with the event template); table of contents title (ex. Table of Contents or Itinerary); journal type (e.g., options may include: table of contents with day/chapter pages, table of contents and no day/chapter pages, no table of contents and no day/chapter pages, no table of contents with day/chapter pages, itinerary page column layout with number of chapters/days in left column, right column), the number of chapters, the photo sets to use with the template, and information for the different days. Each day may have a title, synopsis information, additional photo set information, in some cases depending on the other configurations. With regard to days/chapters, the title may be used as the title for the day/event in the itinerary and for the title of day/event page. The synopsis, which is a bulleted highlight of the day/chapter, may be included in the itinerary page and the day/chapter page sidebars. Photosets optionally may be assigned to a particular chapter/day.

Referring to FIG. 8, other configuration for an event template may include an event/location name subtitle, event details and other such configuration as title and subtitle for welcome pages (usually the trip or event name); a number (e.g., up to 3 or more) side bar thumbnail images to be used on the web pages viewed by the user, such as a participant welcome web page, event details web page and ‘Your Journal’ web page.

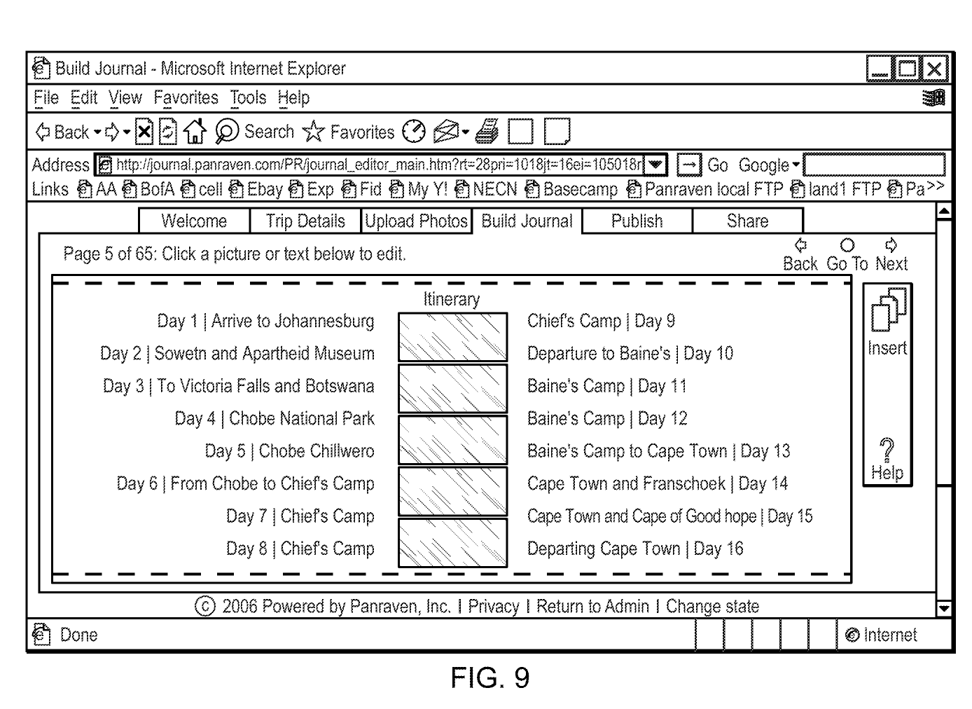

Referring to FIG. 9, an exemplary itinerary page layout is shown with 8 day/chapters on left and another 8 day/chapters on the right. Each chapter may have a short synopsis that is included under the title of the day. This same information or different information may be included on the chapter/day pages themselves. Chapter/day sidebars contain a short synopsis of chapter/day.

Journal Editing

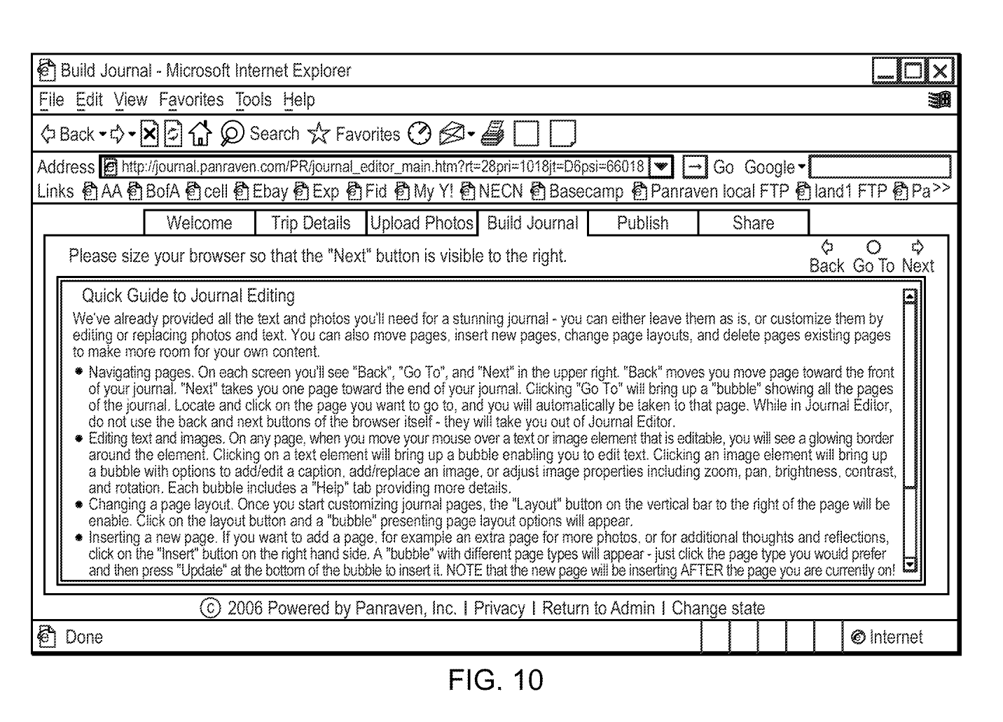

Referring to FIG. 10, when basic setup of an event template is complete, a skeleton of a new journal may be automatically populated with a cover page, an itinerary page (if selected), and a chapter/day summary page (if selected) for each chapter/day. A next step in creating an event template is to use the journal editor, add pages selected from the page layout library, and to add text and photos to all the pages of the journal. As described in the figure, using the journal editor, users can navigate pages, edit text and images, change a page layout, insert new (additional) pages, reorder pages, and delete pages. Preferably, the journal editor is provided as part of the web page application.

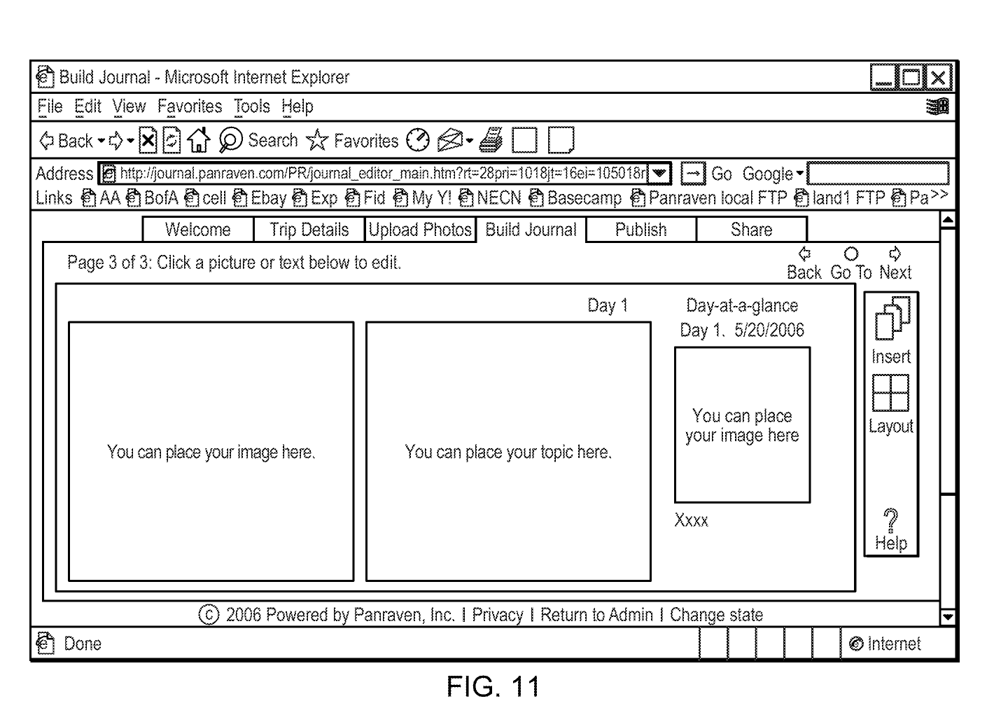

Referring to FIG. 11, a journal editing screen (which may be used to create a page of an event template, or a page of a user's journal) may be used to insert images and text. Typically, a user's page will be pre-populated with some background and/or text information, but it may be possible for a user to have a blank page as shown. In some embodiments, the user selects an area to be edited, and contextually relevant tools are provided. For example, if a user selects a text area, such as “You can place your topic here,” text controls appear, and the user can edit the text in that area. As another example, if a user selects a graphic area “You can place your image here,” a tool that allows a user to select from available images (e.g., uploaded by the user, in a photo set, and so forth) is shown so that the user can select the image to include. As one more example, if the user selects the background, background colors and images may be added.

Creating and Editing an Event

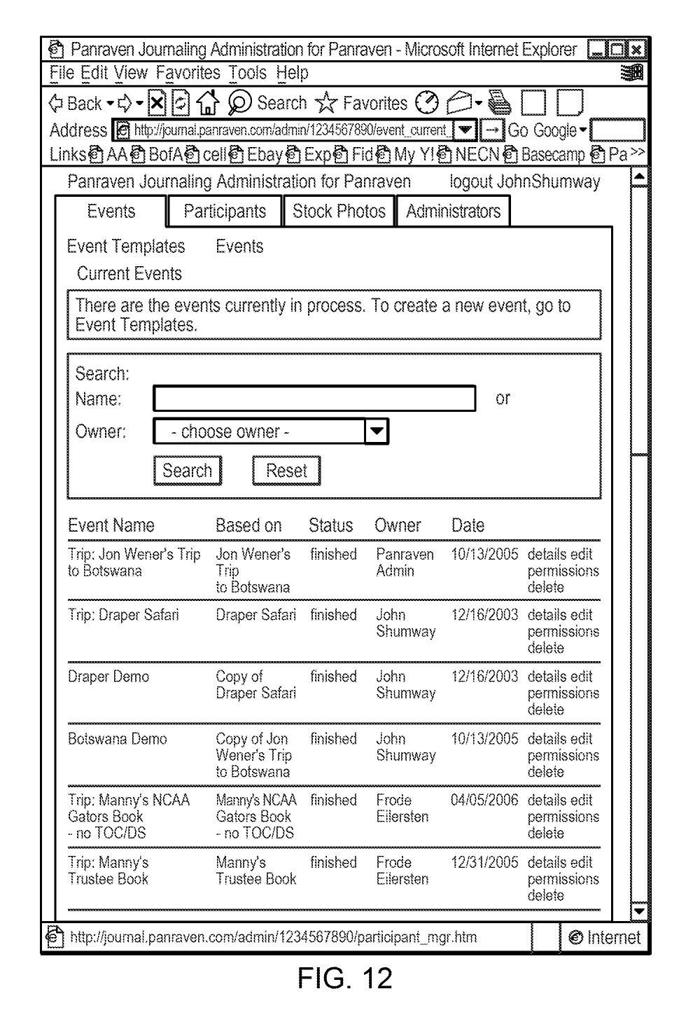

Referring to FIG. 12, once an event template has been pre-populated with content as desired, an administrator may create one or more master event journals from the event template by selecting “create event” and entering a start date and unique event code for the particular event. The basic setup fields described above with respect to the template may be modified for a specific event. A list of events may be shown, to allow editing of details about the event, and the information associated with the event. It should be understood that it may be possible to populate an event template with any amount of information, and that the event may be very different or identical to the event template, depending on the type of event and the administrator's preferences. It also should be understood that in some embodiments, the master journal is an event template, rather than generated from an event template. In such implementations, there may not be master journals.

In instances where there are event templates and master event journals, an administrator may make changes to an event by editing the event journal at the event level. These changes will be specific to the particular master event journal, rather than at the event template level. One benefit of the event template and event customization is to allow for small differences in itinerary that routinely occur (ex. staying at a different hotel, more or less time in particular location, etc.).

Publishing an Event

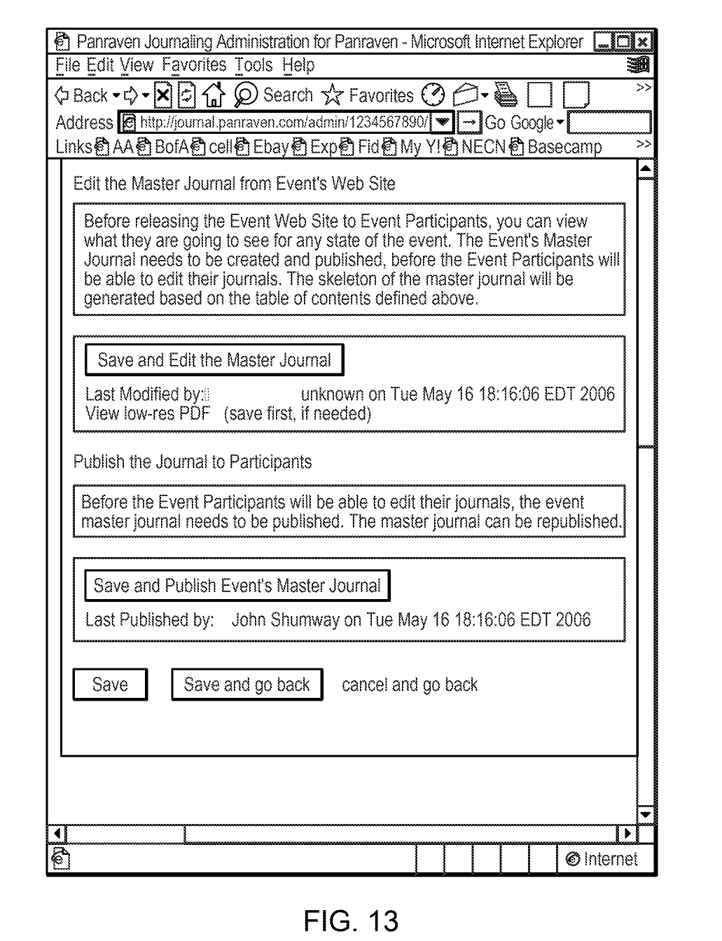

Referring to FIG. 13, once editing of an event is complete, the event may be ‘published.’ When an event has been published, participants may self-register or be assigned to the event by an administrator. In the embodiment shown, an administrator may save and edit the master journal for an event, and then may publish the event's master journal by selecting the appropriate button.

Defining Participants

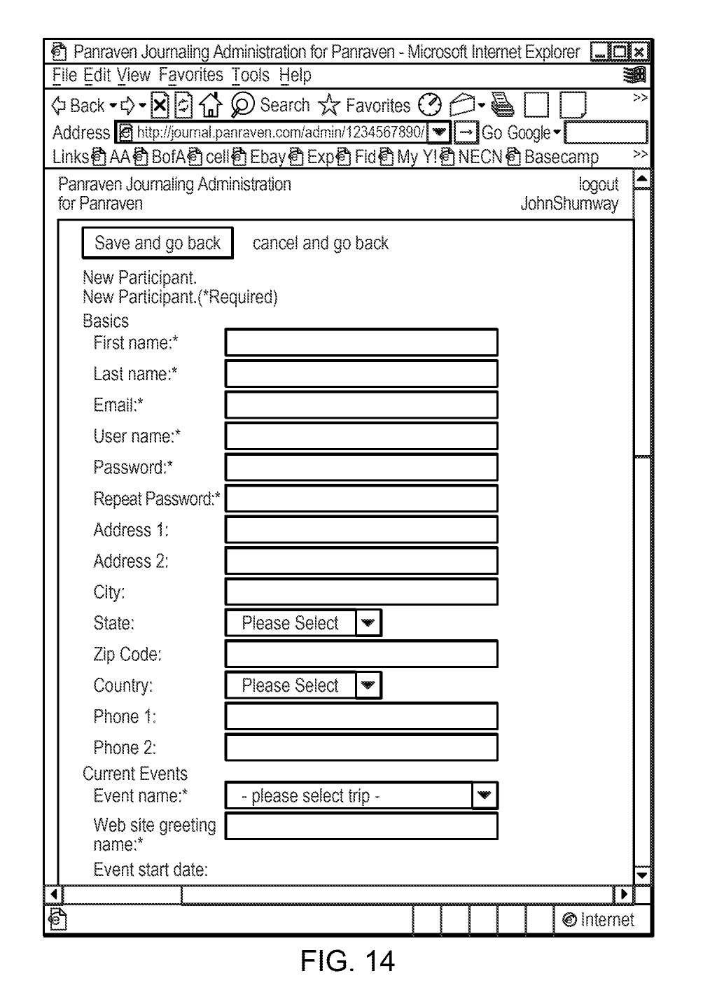

Referring to FIG. 14, participants can also be defined and associated with a particular event by an administrator or through an automated feed from the operator/partner. An exemplary interface is shown, in which the participant's name, email, username, password, address, and telephone number may be configured, along with the event name, the web site greeting name. The event start date may be selected and/or provided by the system based on the event start date. In this way, in the context of a travel event, a tour operator may configure the travelers who can participate in the service, and build a journal based on an event template and/or a master event journal.

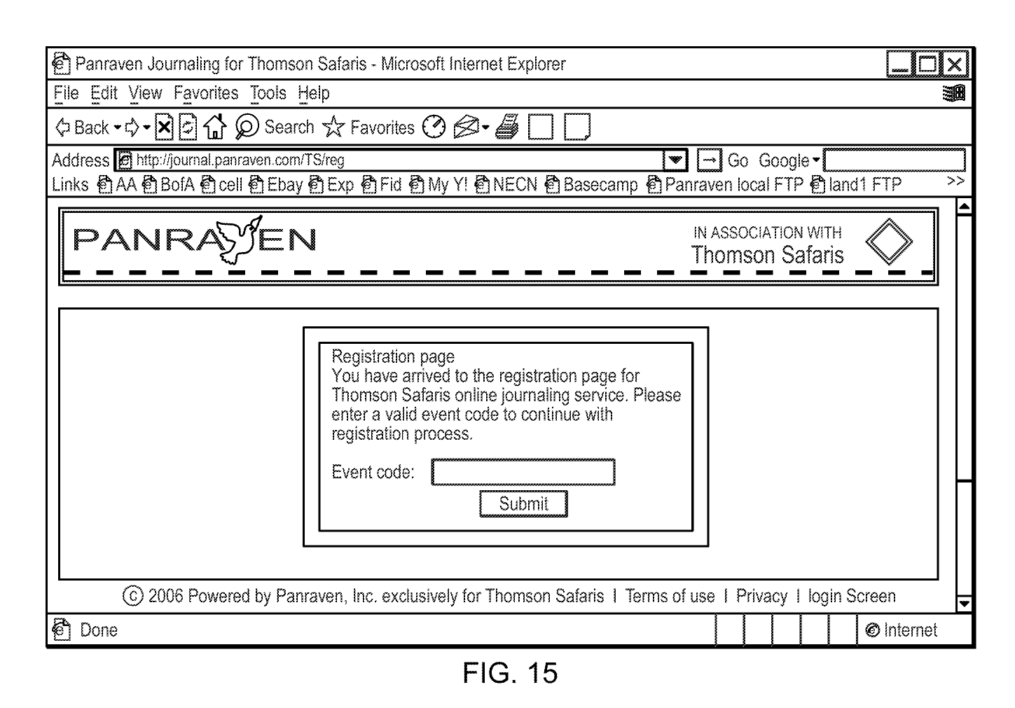

Referring to FIG. 15, in some embodiments, participants may self-register for published events by accessing a special web URL and entering a preconfigured and/or assigned event code.

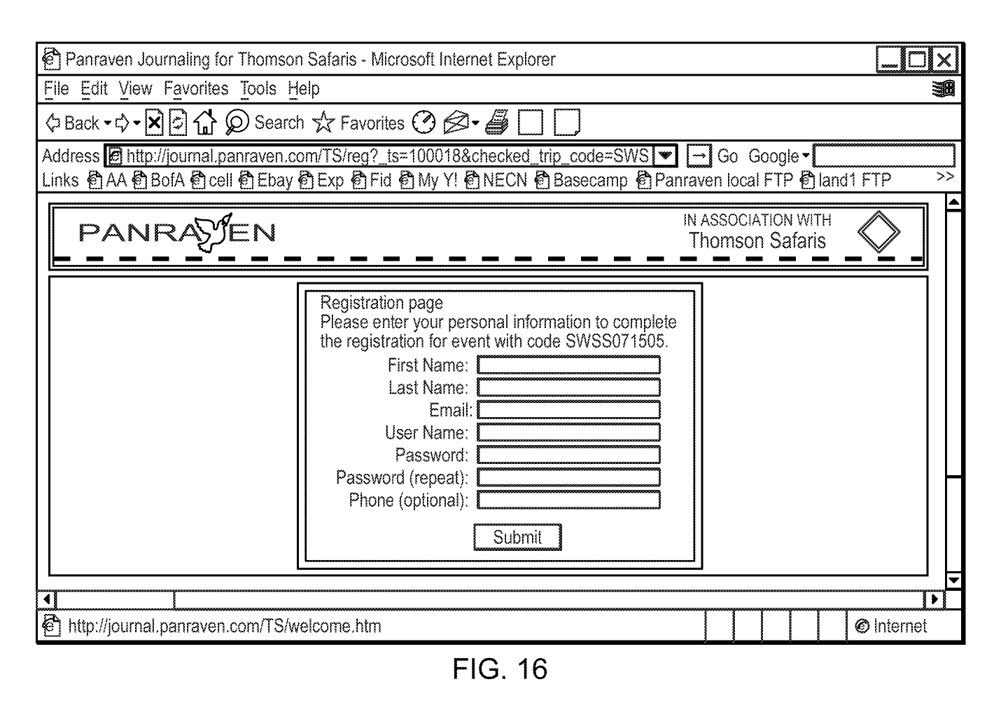

Referring to FIG. 16, in some embodiments, after providing an event code, participants may provide a username and password so that they can be recognized by the system.

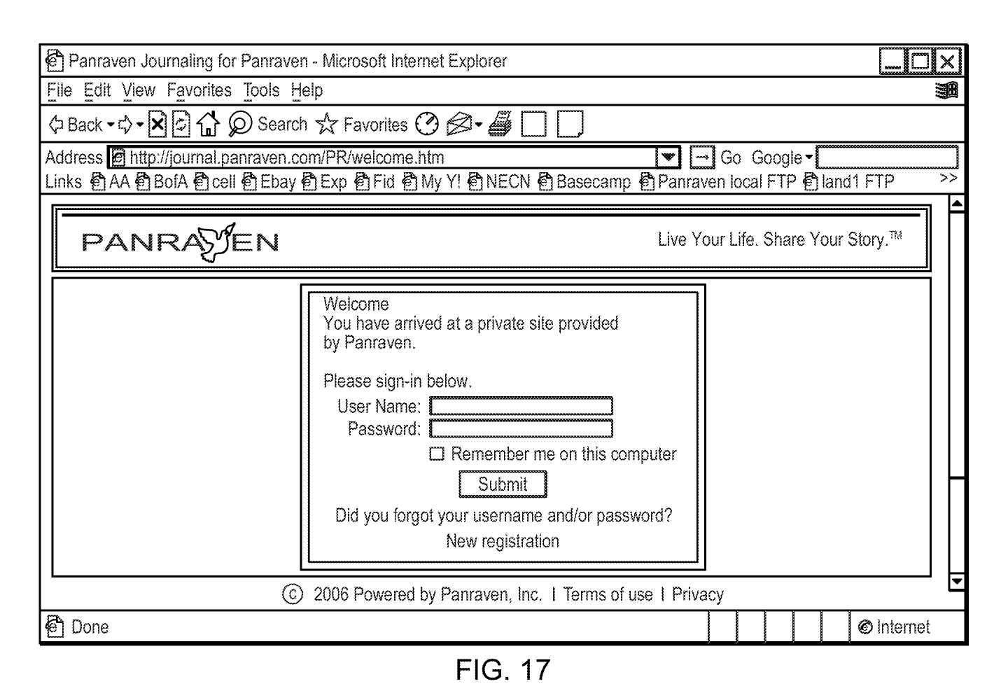

Referring to FIG. 17, once registered, participants can log in to the system and access their personalized web pages and journal. At a login page, they are asked to enter the user name and password defined at registration.

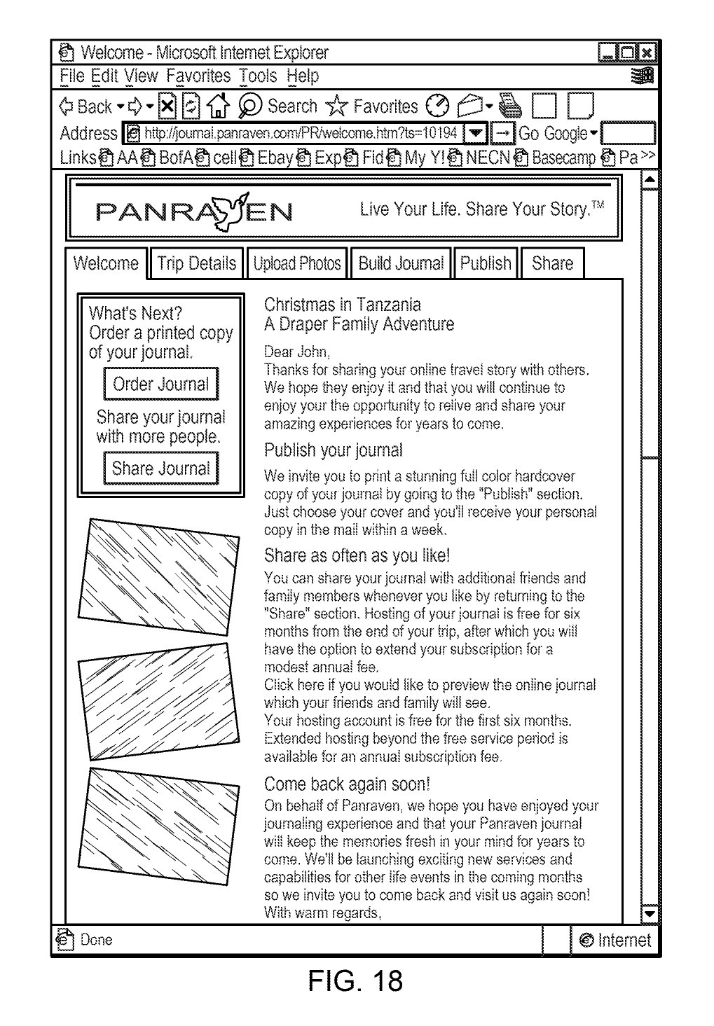

Referring to FIG. 18, an exemplary participant welcome page is provided that includes information (e.g., name, trip information) that is specific to the participant. Additional information about the service also is provided. The welcome page may be state sensitive, such that there are different options depending on whether the trip has begun, the user has begun to populate the journal with information, and so forth.

Participant Media File Upload

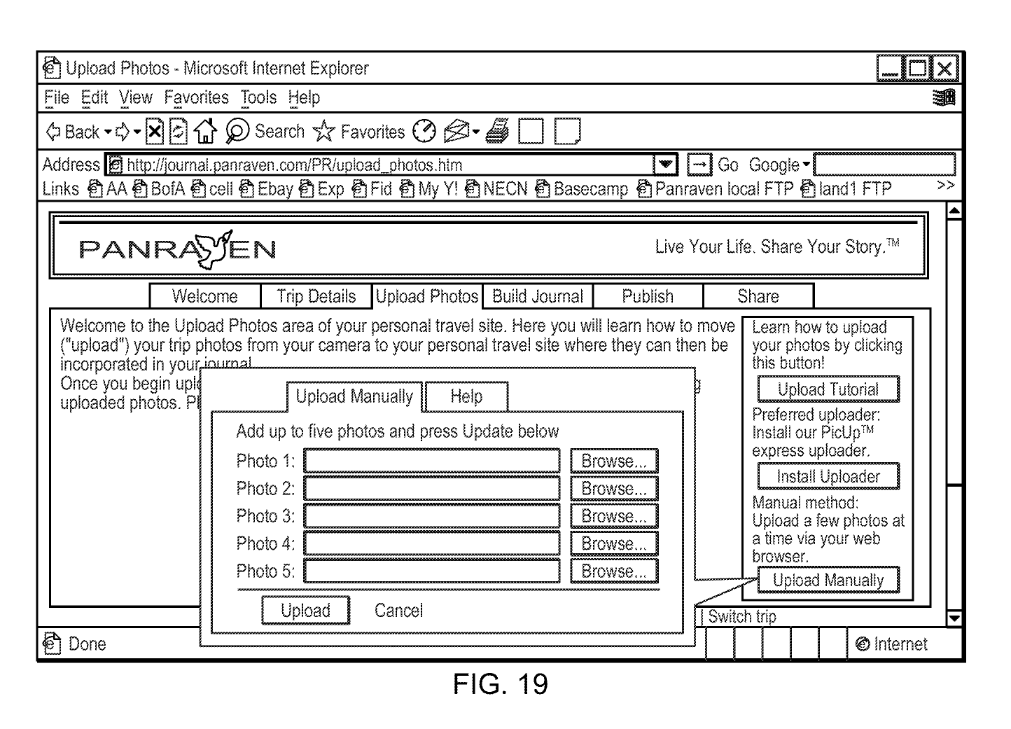

Referring to FIG. 19, post-trip, users are first directed to upload their personal media files (for example, photos) using a manual browser based upload or by installing the uploader application. Photos uploaded by the participant become available in the ‘My Photos’ section of Journal Editor. As shown in the figure, the upload may be accomplished within a web page.

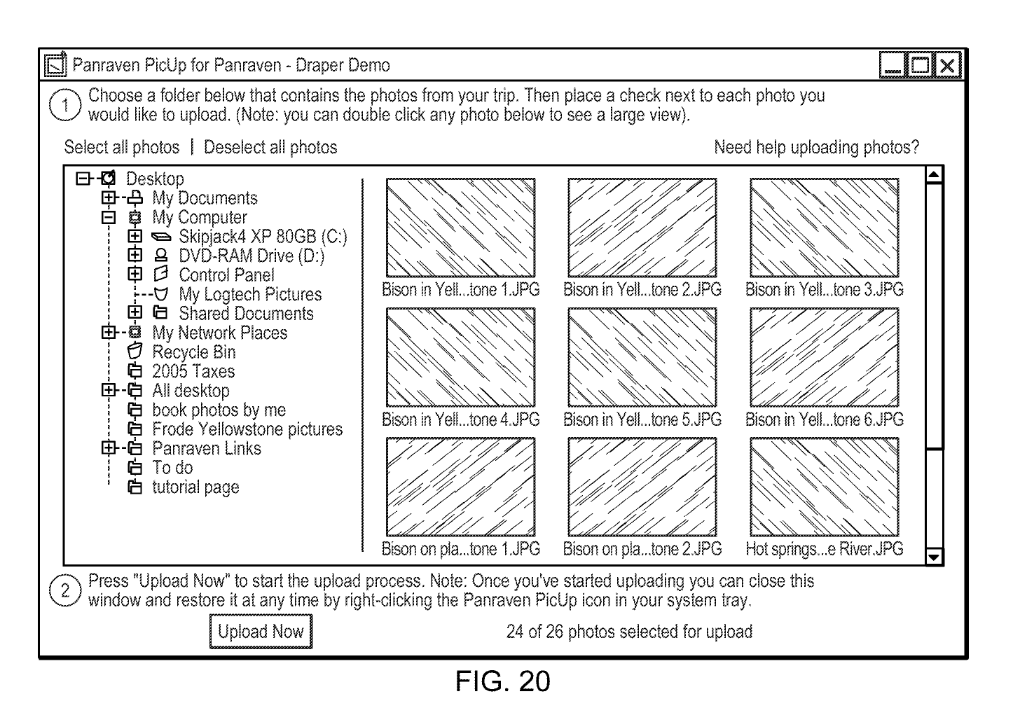

Referring to FIG. 20, a photo uploader application may be used to send photos to the server.

Participant Journal Editing/Publishing

In various embodiments, a participant may edit his/her journal using the same tools as described above with respect to event template and event master journal editing. A user may select photos, text, and so forth, making any changes desired. Typically, there will be some places for the participant to add text and/or photos, and the participant may choose to replace some of the photos and/or text in the template with his/her own. The user also may add additional pages, delete pages, change the location of figures, and so on.

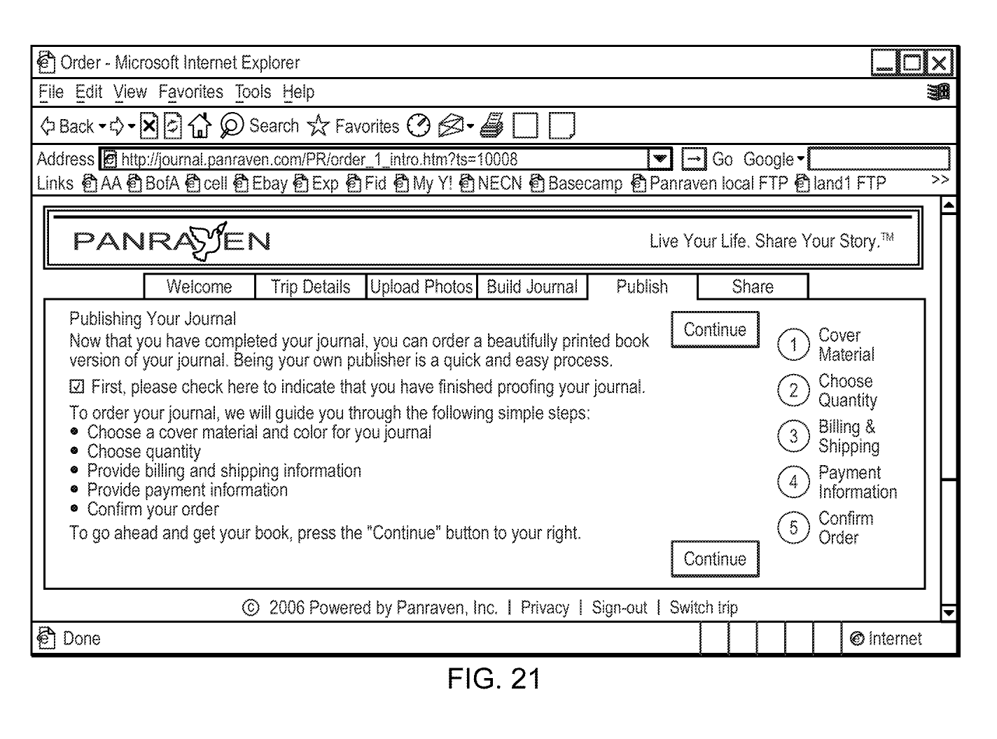

Referring to FIG. 21, once complete, participants may order journals through an integrated web storefront.

Sharing

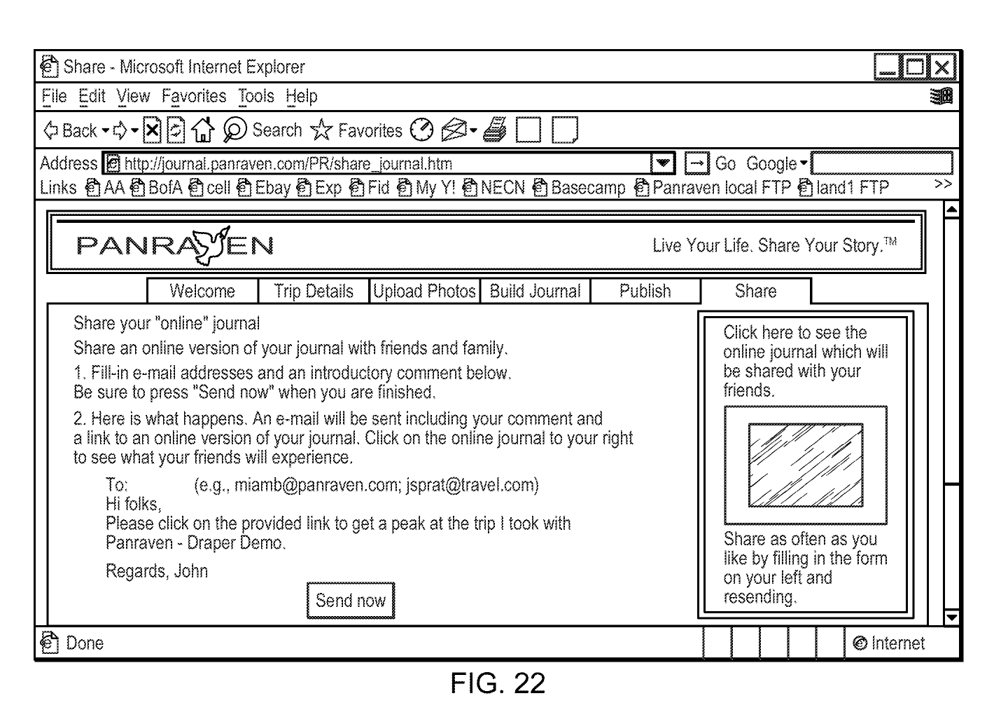

Referring to FIG. 22, participants may share their journals online through customizable, system generated email invitations. When a journal is shared, a link is provided to a WYSIWYG version of the journal that looks like the printed version. A user may share a journal such that others can view the journal. A user also may share a journal such that another user can have a copy of the journal to edit themselves. In this way a user essentially can create a replica or snapshot copy that may be edited by others. A user also may share access to a journal so that a group of users may work together to edit and produce a journal.

Architecture Overview

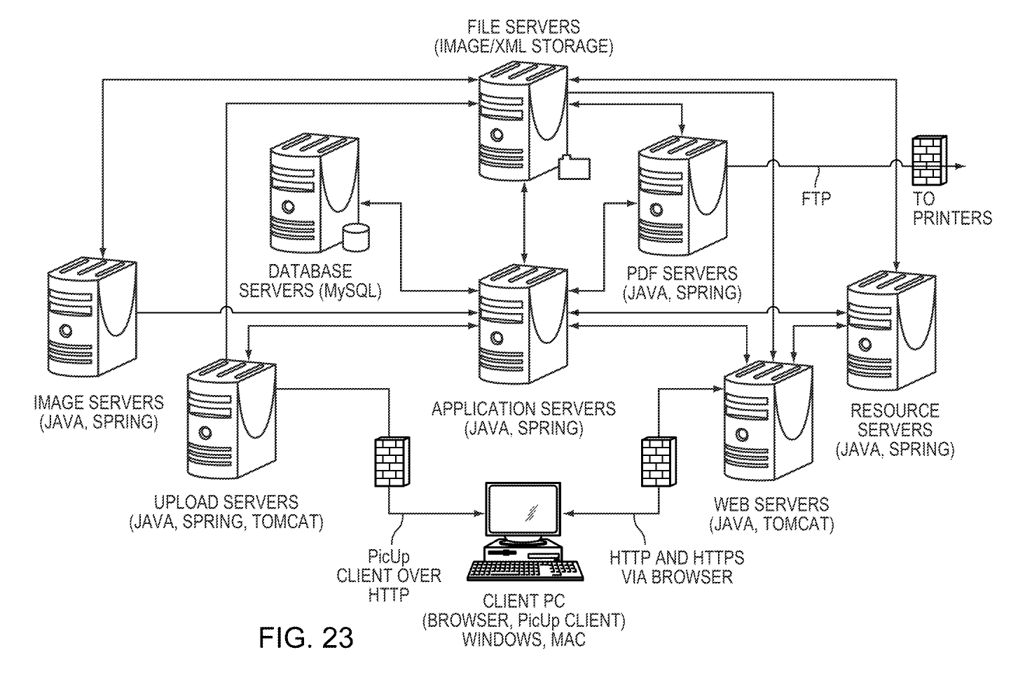

Referring to FIG. 23, in one embodiment, a system is provided with the capability of providing the functions described here using a client/server model. The system performs the compute-heavy processing on the servers to provide a fast and rich browser user experience. The service uses Java technology (Spring, JDBC, etc) on the servers and AJAX (Asynchronous JavaScript And XML) on the front-end browsers to provide users with features on the browser, yet with all the power of server processing.

In some implementations, processing is divided up into a several different clusters of servers responsible for specific modular tasks. The solution is server-CPU intensive, but is highly scalable as new servers can always be added to the existing cluster to improve the performance. New types of server clusters can easily be introduced to support additional functionality.

The user typically has a web browser with HTML (HyperText Markup Language), CSS (Cascading Style Sheets) and AJAX on a client PC (Personal Computer) to communicate to the servers through HTTP (HyperText Transport Protocol) and HTTPS (HTTP Secure) protocols with Web Servers to provide all the data, instructions, and graphical screen experience for all the administrator and end users.

Web Servers talk to Application Servers using RPC (Remote Procedure Call) calls which in turn accesses Database Servers using JDBC (Java DataBase Connectivity) for all the database needs. File Servers are accessed by all the servers using NFS (Network File System) and HTTP for various media (photos, etc) and data XML (eXtensible Markup Language) documents stored there.

Resource Servers may provide WYSIWYG (“What You See Is What You Get”) text renderings in JPEG form which are unique to the size of the client's web browser window and the resolution of the client's screen.

PicUp, an uploader application, allows the user to upload media files (for example, digital photos) to the service's Upload Servers using HTTP in the background, remembering the state of the selection and upload status for future upload sessions.

Upload Servers receive the media files from PicUp automated uploads or from direct browser uploads (e.g., individual file selections through the web browser window) and communicate the media data to the file servers for processing by image servers.

Image servers monitor for newly uploaded photos to be processed and create necessary multiple versions (e.g., a higher resolution and lower resolution) photo/video files on the file servers used by the rest of the system, and notifies application servers to make the media files available (as appropriate) to the rest of the system by updating the database.

When a user places an order for a physical printed journal, a PDF (Portable Document Format) servers receive that information from an application server and using high resolution images makes a PDF that is communicated (e.g., by FTP) to a printing service (e.g., a commercial printer) for printing and shipping to the customer.

Database Servers: Database

In some embodiments, a database design for such a life recording system includes a number of relational database tables that store the information defined by an administrator such as but not limited to administrator users and their roles and permissions, event templates and events, participants, providers, high level life event information, and image references. Images themselves may be, but typically are not stored in the database. Likewise, journal data may be but typically is not stored in the database, but in data XML files. In some embodiments, only application servers have access to the database making sure that no data integrity issues occur. Database servers use MySQL Cluster database to host a high availability, high performance, in-memory database.

File Servers: NAS Storage

In some embodiments, a system uses NAS (Network Accessible Storage) storage to allow for scalable means of storage using commodity hard drives. Directories in the NAS environment are available to the system's servers via NFS and HTTP protocols. The customer-uploaded photo collection, as well as stock photography, may reside in a hierarchical directory structure identified by provider, event, participant, and journal numbers that correlate with database unique identifiers allowing for efficient image retrieval.

Web Servers: Individual Site Provisioning

In some embodiments, web servers for the life recording system are Apache Tomcat servers that process mostly JSP pages which are developed using Spring lightweight container framework. The traffic load on the Web Servers is scaled using load balancer appliances. There are two web applications served by web servers: the administrator site and the participant site. The administrator site allows for provisioning of the stock photography and point of interest content, event templates and events and ultimately participants that will have access to one or more events. These events can be accessed by a unique site either for a provider or a participant. This is done dynamically allowing an administrator to modify the look and feel of the site available to the participant based on various criteria (i.e. images, text messages, dynamic content, etc). Web Servers communicate with Application and Resource Servers through RPC and File Servers through NFS and HTTP protocols.

Application Servers: Traffic Cop

In some embodiments, the Application Servers in the life recording system acts the conduits between Web, Image, PDF and Database servers. They are the conduit to access to the database thus maintaining data integrity of the database. They also cache certain database data increasing the overall performance of the system. Email traffic gets sent using Application Servers. In some embodiments, the application servers are the JBOSS application servers available from RED HAT, INC.

Resource Servers: WYSIWYG Text on Demand and Low Resolution PDFs

In some embodiments, the Resource Servers provide important functionality for the system. These server perform the WYSIWYG image generation of any text requested by any Web Servers and dynamic background composition. The available Resource Servers advertise themselves to the Web and Application Servers, so these servers can be added on as need basis according to the load on the system. As a Web Server sends a request along with XML piece from the data XML describing the needed look and feel as well as the text itself, the underlying Java process uses Java libraries, as well as a lot of custom code, to create a WYSIWYG rendition of that text in JPG format which is in turn passed back to the Web Server to be served to the client using AJAX. The result is a text image which is anti-aliased and thus looks readable even on the smaller screen resolutions. As the user changes the text and/or resizes the browser, Resource Servers regenerate the text images to fit the new dimension always assuring a true WYSIWYG experience.

Front-End: Behind the Browser

In some embodiments, the user uses the native browser on their operating system to access the system over the network. Using standard browser technologies such as HTML, CSS, JavaScript and XML, the user can producing professional quality content, and then have that content memorialized into a book. The administrator and participant sites may be implemented with standard HTML, CSS and JavaScript constructs. The journal editor portion of the participant site may use an AJAX engine to communicate with Web Servers using data XML as the protocol of communication. AJAX allows systems to update those portions of the screen that have changed since last update action, giving a high response user experience to the user. Various JavaScript artifacts such as ability to show and move transparent bubble windows, may help make the user feel like they are using a desktop application and not a browser based application.

Client Uploader and Upload Servers: Background Upload Client

In some embodiments, a user may upload photographs directly from the Participant site using manual HTML upload for up to five photos at a time, not being able to close the browser during the upload transfer or loosing their upload session. In some implementations, a native upload application that can be downloaded to the client's machine allows for an intuitive selection of customers photos and ability to upload them in the background. The background upload process may stop itself upon completion of the upload. Even if the upload session is killed or computer is rebooted, the user will have an opportunity to continue the upload session at a later time without worrying that their selection has been lost. The upload state is tracked and remembered by the upload client application. An upload client may communicate with an uploader server using HTTP. The available uploader server may be determined using a Load Balancer appliance. As the photographs come in to the uploader server, they get put into an incoming images directories, based on provider, event and participant, to be processed by the image servers.

Image Servers: Photo Processing

In some embodiments, an image server's job is to take newly uploaded images and create appropriate high resolution, low resolution, and thumbnail images for those photographs and appropriately place them onto the file server and notify the application server that they are available to the rest of the life event recording system. The low resolution and thumbnail images are used throughout the system by the Web Servers to serve back to the browser to display the images when user selects them. The high resolution images are used by the PDF Servers to create the printable PDF.

PDF Servers: High Resolution PDFs Ready for Printing

The life event recording system allows the publishing journals, for example as a professional looking book in addition to on-line viewing. That book may be created by the PDF Servers using the underlying data XML document and the high resolution photographs that the user has uploaded originally. Multiple PDF Servers may make themselves available to the system and the least busy one will produce the PDF. The XML describing the PDF printing job may be produced along with the PDF. The PDF and XML file may be stored in an archive file (e.g., a zip file) and communicated (e.g., via FTP) to a printing partner which in turns can read the XML job file, process the PDF, and print a book that is in turn gets sent to the customer. The life event recording system can also receive communications from the printing house in cases such as delayed shipment or other issues and deal with them accordingly.

WYSIWYG Display

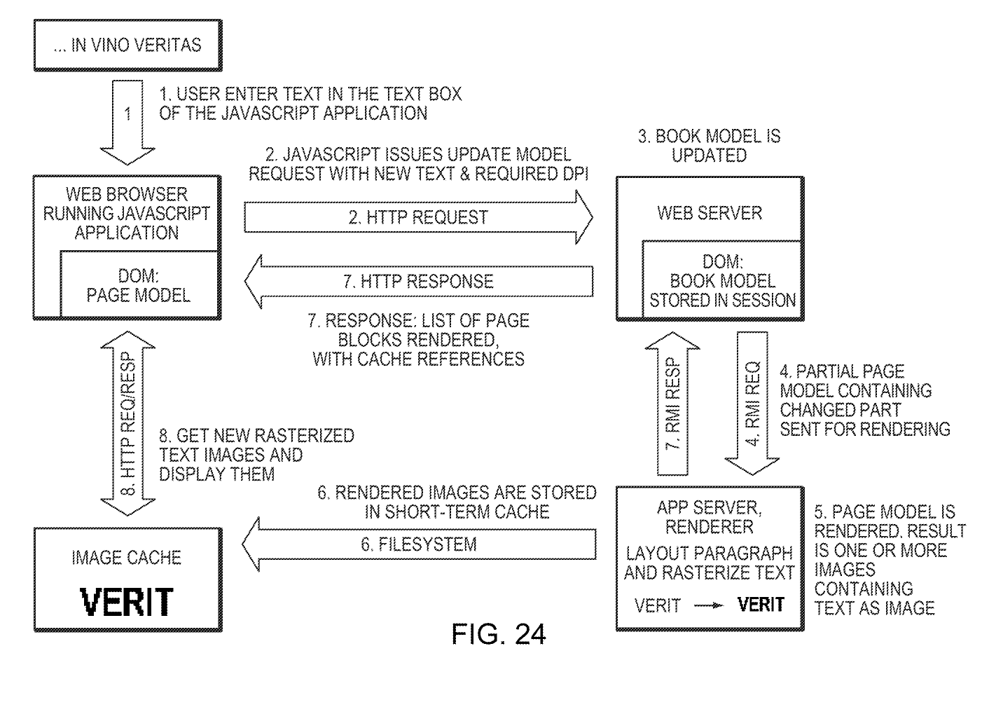

Referring to FIG. 24, in some embodiments, a life event recording system's architecture creates a highly scalable, modular and expandable system that allows a web browser end user to have the same or better experience as a desktop application. To achieve this, text data displayed to and/or entered by the user in the context of the user's journal and/or template is converted to an image presentation (e.g., a graphical file format, such as JPG, PNG, BMP, etc) of the text by the servers. Such graphical representation is then rendered on the end user's output device (i.e. on-screen, in print, cell phone, etc) as an image providing a dynamic real-time WYSIWYG (“What You See Is What You Get”) format.

For example, to implement the functionality described here on a desktop software typically needs to specify and render various fonts in different non-standard sizes (e.g., 6.7 points, 9.3 points, 8.6 points, etc.) and not just integer values, and place text and graphics accurately on a particular canvas of a certain size. In most cases, an end-user with a browser does not have access to the custom fonts or font logic required to produce necessary output, since these are not available through standard HTML in a web browser. In addition, a browser may not have the ability to accurately place rendered fonts in coordination with graphics on a page.

Other media such as background graphics also would need to be readily available on the user's computer. There is also a problem of rendering this text together with other media such as for example background graphics and photos to a wide variety of media such as screens, printers, mobile devices, etc. that have very different resolution (=number of pixels required to render the text/image on the particular medium) needs. Thus, the output size may vary, but the quality of that rendering needs to remain high.

Communication Layer

The information about the data that needs to be rendered may be defined in any specification language, for example, XML (eXtensible Markup Language). The rendering information is captured in a document describing all possible variations of canvas layouts (for example, a book page) and the look and feel of the page (fonts, graphics, object shapes, locations and size of these fonts and graphics). The coordinates are defined for a particular medium for a particular size. These coordinates act as a baseline for any future changes and renderings. This file is fairly small while compressed (about 10 KB) allowing for easy transfer of it between various servers thus acting not only as data but also as a protocol of communications between browser and the servers that render the correct medium.

An example of a language specification model is as follows:

<page dpi=“300”>

<frame x=“100” y=“100” width=“300” height=“300”>

<image location=“/storage/image1.jpg”>

</frame>
<frame x=“500” y=“100” width=“300” height=“300” align=“left”

valign=“top”>

<text style=“Times 12pt bold” color=“black”>

The horse is good!

</text>

</frame>

</page>

Server Based Rendering

The correct fonts and other necessary media required for creating the final output for screen or other mediums are readily available on the life event recording system's servers. The rendering server process reads in the data language specification document and the target output canvas size and type to be rendered and then adjusts the coordinates for the target medium size and resolution taking into consideration, for example, anti-aliasing and any other processing that needs to be performed. It then pulls together the “raw materials” (fonts and media files) required for rendering, and then creates a unique JPEG, PDF, or other target format (in case of text rendering) that is specific to the target area of the browser or printer page that needs to be rendered.

Dynamic Results

When a page of a document that the user sees on their browser needs to be re-rendered due to, for example, the user resizing the browser window, there is an HTML request to the server passing the changes in the specification language document format. The rendering server reprocesses the changes adjusting the coordinates of all the objects that are described in the data specification language document with a coefficient based on the target canvas size and type sent over by the client and sends back the newly generated JPEG file(s) back to the browser.

If the user decides to change the existing text on the client side, the data specification language document is updated to reflect the new text before being sent back to the rendering server. When the Rendering Server receives the text change request, it will regenerate the new image file (e.g., JPEG) containing the correct look and feel of the newly changed text in the appropriate size and resolution.

This is not limited to the JPEG renderings in the browser. The same document can be rendered multiple times in different sizes to different parts of screen, printed page, or any current or potential future mediums.

It should be understood that this dynamic text rendering technology may be accomplished for purposes of a life event recording system, but may also be used in other web applications in which it is desired to demonstrate to the user what the final output of web desktop publishing operations might be. For example, business presentations and personalized marketing brochures, as non-limiting examples, might be implemented using this dynamic web WYSIWYG display technology.

Referring still to FIG. 24, in some embodiments a user is presented with a web page with a location for entering and/or editing text. For example, the user may select a text box on a page editing screen. (1) The user enters text in the text box. (2) Browser code (e.g., javascript code running on the browser) issues an UPDATE MODEL request with the new text along with the desired resolution (e.g., in the form of the DPI). (3) The model of the document (e.g., the journal, book or other document) is updated. (4) A partial page model containing changed part is sent to a rendering server for rendering. (5) The page model is rendered, and the result is one or more images containing text as an image rendered at the desired resolution. (6) Rendered images are stored in a data store, such as a short-term cache. (7) The rendering server responds to the rendering request with a list of page blocks rendered, and cache references. Thus, the rendered result may be in the form of one or more images stored in the cache, accessible with URL's. The web server responds to the browser with the list of blocks rendered, and cache URL's. (8) The browser then may download the new rasterized text images and display them.

In one embodiment, an entire journal page is rendered as one graphic image or as pieces of a graphic image, that together display a page as it would look on paper, converted appropriately to the size and resolution of the display. In another embodiment, different parts of a page (e.g., text, graphics, background) are each converted separately to separate images at the desired resolution and size, and are together rendered in the browser to image a page of the journal.

Life Event Recording Platform

It should be understood that the life event recording system can help people capture heterogeneous media in digital form and using this life recording system create stories and publish and share these stories, both online (via any kind of screen, from the smallest mobile phone screen all the way up to the highest resolution monitor or television) or in print (from individual sheets such as posters, via soft cover or stapled sets of sheets such as a calendar, to hardcover books and any other personalized merchandize such as mugs, T-shirts, mouse pads, etc).

One focus of the life recording platform is rich storytelling, incorporating heterogeneous media (in digital form, such as digital photos—scanned or natively digital—text, video clips, audio clips, any kind of graphics or illustration, etc) and formatting it to create a “story”. Story here is used to encompass a wide spectrum of organized communications, from an uncommented 1-photo episode about a walk in the woods all the way to a richly illustrated and complete “life story” consisting of thousands of words of text, photographs, audio/video clips, and elaborate graphics.

The life recording system consists of a number of elements, each of which is integrated into an overall workflow, but whose main purpose is to make it as effortless as possible for a user to capture and express an experience quite richly and individually, and yet with minimal amount of effort, by having most of the content, layout and visual artistic work done for him/her by the life recording system. This includes providing the most realistic user interface (so-called WYSIWYG) as accessible as possible (via the Internet through the web browser), with pre-made storyboards, pre-made graphics, pre-made content (both background information and photos), and through the collaborative sharing of media/content for use in the creation process.

While each of the elements described below are valuable components of the overall life recording system, this list of components is neither an exhaustive list, nor are any of the components necessary in order to provide the overall life recording system.

1. A method for facilitating on-line creation of a journal for a life event, comprising:
creating a template storyboard relevant to the life event;
prepopulating the storyboard with content relevant to the life event;
receiving content from a user;
facilitating the editing and personalization of the storyboard by the user, including adding the content received from the user; and
providing the user with a journal in response to the edited storyboard.

2. The method of claim 1, wherein the content comprises a photograph.

3. A system for creating a journal specific to a life event, comprising:
an upload server for receiving from a user uploaded photographs taken at the event;
a web server for providing an editing environment for editing journal content, the content comprising the uploaded photos, a storyboard for the event, graphics relevant to the event, prepopulated information relevant to the event, and text provided by the user;
a resource server for translating the edited journal content into a WYSIWYG file for display to the user.

4. The method of claim 3, further comprising a transmitter for transmitting the journal content to a printer.

5. The method of claim 4 wherein the life event is a trip, wedding, religious event, music event, educational event, and/or sports event.

6. A method for providing a WYSIWYG editing environment for a graphic product, comprising:
receiving browser size and resolution data from a browser;
facilitating the editing and personalization of a graphic product by a user;
generating a graphic file representative of the graphic product in response to the browser size and resolution data and the editing and personalization provided by the user; and
transmitting the graphic file for display on the user's browser.

7. The method of claim 6, further comprising transmitting the graphic file to a printer for printing.
